(19) United States
(12) Patent Application Publication
(10) Pub. No.: US 2026/0292754 A1
(43) Pub. Date: Sep. 24, 2026

(54) UNAVAILABILITY PERIOD AND COVERAGE NOTIFICATION INDICATION IN MOBILE COMMUNICATIONS

(71) Applicant: MediaTek Singapore Pte. Ltd., Singapore (SG)

(72) Inventors: Puneet ., Bengaluru (IN); Marko NIEMI, Oulu (FI)

(73) Assignee: MediaTek Singapore Pte. Ltd., Singapore (SG)

(21) Appl. No.: 19/473,897

(22) PCT Filed: Sep. 4, 2024
(86) PCT No.: PCT/CN2024/116806

§ 371 Date: Oct. 9, 2025

(30) Foreign Application Priority Data
Oct. 18, 2023 (IN) 202321071058

(51) Int. Cl. H04W 60/06; H04W 8/08

(52) U.S. Cl. CPC H04W 60/06; H04W 8/08

(57) ABSTRACT

Techniques pertaining to unavailability period and coverage notification indication in mobile communications are described. An apparatus (e.g., a user equipment (UE) ) determines whether the UE needs to report an end of an unavailability period to a network upon returning in coverage after being in discontinuous coverage. In response to the determining, the apparatus performs either or both of: (a) entering a 5th Generation Mobility Management (5GMM) state depending on a state of the UE; and (b) controlling a wait timer according to the determining.

### CROSS REFERENCE TO RELATED PATENT APPLICATION(S)

The present disclosure claims the priority benefit of Indian Patent Application No. 202321071058, filed 18 Oct. 2023, the content of which herein being incorporated by reference in its entirety.

### TECHNICAL FIELD

The present disclosure is generally related to mobile communications and, more particularly, to unavailability period and coverage notification indication in mobile communications.

### BACKGROUND

In wireless communications such as mobile communications under the current 3^{rd} Generation Partnership Project (3GPP) specification, for both a user equipment (UE) and a network supporting unavailability period and the unavailability is due to satellite discontinuous coverage, the Access & Mobility Management Function (AMF) of the network may set a return to coverage notification indication value to “notification is not required”, and the AMF may provide it to the UE. Upon receiving the indication, the UE is not required to trigger a registration procedure when the unavailability period duration has ended. If the indication sets other values or the AMF does not provide it to the UE, the UE should trigger a registration procedure for mobility registration update when the unavailability period duration has ended.

When the AMF sends the coverage notification indication value to “notification is not required”, the UE does not need to trigger a registration procedure when unavailability period is completed. However, when the UE is not required to trigger a registration procedure when the unavailability period is over, which 5^{th} Generation Mobility Management (5GMM) the UE should be in has not been defined in the current 3GPP specification. Moreover, whether or not the UE should start a discontinuous coverage maximum non-access stratum (NAS) signaling wait timer has not been defined in the current 3GPP specification. Therefore, there is a need for solutions of unavailability period and coverage notification indication in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to unavailability period and coverage notification indication in mobile communications. It is believed that implementations of one or more of the schemes proposed herein may address or otherwise alleviate the issues described above.

In one aspect, a method may involve a UE determining whether the UE needs to report an end of an unavailability period to a network upon returning in coverage after being in discontinuous coverage. The method may also involve the UE performing, responsive to the determining, either or both of: (a) entering a 5GMM state depending on a state of the UE; and (b) controlling a wait timer according to the determining.

In another aspect, an apparatus may include a transceiver configured to communicate wirelessly and a processor coupled to the transceiver. The processor may determine whether the UE needs to report an end of an unavailability period to a network upon returning in coverage after being in discontinuous coverage. The processor may also perform, responsive to the determining, either or both of: (a) entering a 5GMM state depending on a state of the UE; and (b) controlling a wait timer according to the determining.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to unavailability period and coverage notification indication in mobile communications. According to the present disclosure, a number of possible solutions may be implemented separately or jointly. That is, although these possible solutions may be described below separately, two or more of these possible solutions may be implemented in one combination or another.

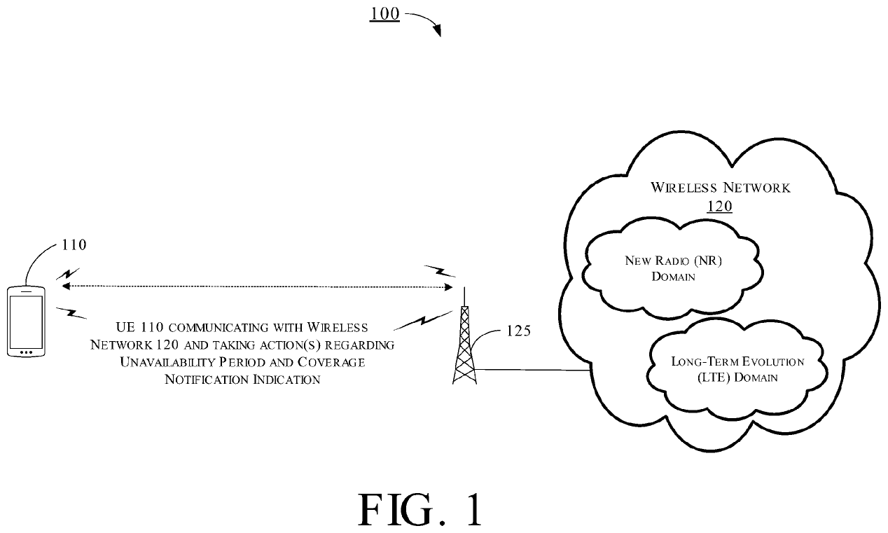

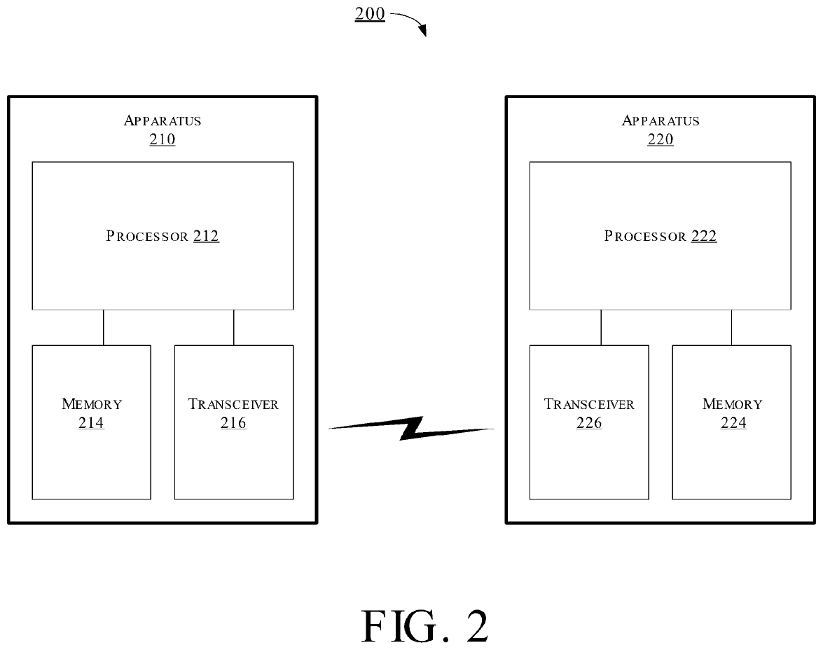

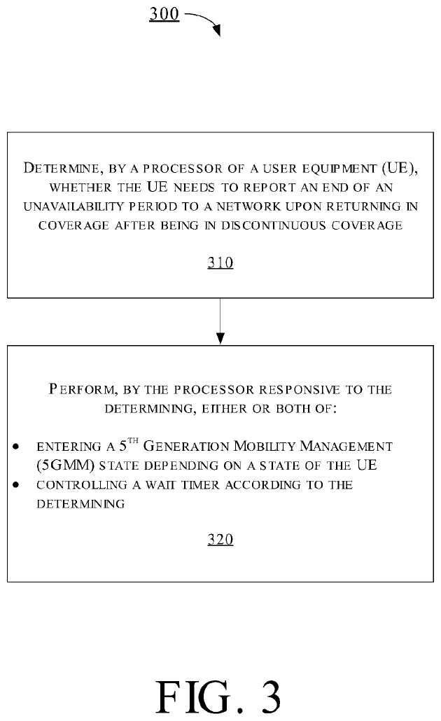

FIG. 1 illustrates an example network environment 100 in which various solutions and schemes in accordance with the present disclosure may be implemented. FIG. 2~FIG. 3 illustrate examples of implementation of various proposed schemes in network environment 100 in accordance with the present disclosure. The following description of various proposed schemes is provided with reference to FIG. 1~FIG. 3.

Referring to FIG. 1, network environment 100 may involve a UE 110, such as a mobile device or smartphone, in wireless communication with a wireless network 120 as part of a communication network. The wireless network 120 may be a PLMN including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to unavailability period and coverage notification indication in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a proposed scheme in accordance with the present disclosure, when AMF of network 120 sets and sends a coverage notification indication value to “notification is not required” and/or unavailability period is over, UE 110 may enter one of the following states: (1) 5GMM-REGISTERED. NORMAL-SERVICE, if UE 110 is in a registered state; (2) 5GMM-DEREGISTERED. NORMAL-SERVICE, if UE 110 is in a de-registration state; (3) 5GMM-REGISTERED. PLMN-SEARCH, if UE 110 is performing search in the registered state; and (4) 5GMM-DEREGISTERED. PLMN-SEARCH, if UE 110 is performing search in the de-registered state.

Under a proposed scheme in accordance with the present disclosure, UE 110 may memorize and store the 5GMM states before activating the unavailability period. When the AMF sets and sends the coverage notification indication value to “notification is not required” and unavailability period is over, UE 110 may enter the same state which was memorized before unavailability period activation.

Under a proposed scheme in accordance with the present disclosure, when the AMF sets and sends the coverage notification indication value to “notification is not required” and unavailability period is over, UE 110 may not start the discontinuous coverage maximum NAS signaling (offset) wait timer. In case the timer is running, UE 110 may stop the timer.

As an implementational example, in case for discontinuous coverage UE 110 has stored a discontinuous coverage maximum time offset, upon returning in coverage of a tracking area (TA) in a current registration after being out of coverage due to discontinuous coverage, and in the last REGISTRATION ACCEPT message the end of unavailability period report was set to “UE needs to report end of unavailability period”, UE 110 may start the discontinuous coverage maximum time offset timer with a random value up to and including the stored discontinuous coverage maximum time offset for the public land mobile network (PLMN) and NR satellite access. Moreover, UE 110 may enter 5GMM-REGISTERED. ATTEMPTING-REGISTRATION-UPDATE state and may not initiate any NAS signaling on that NR satellite access and PLMN while the discontinuous coverage maximum time offset timer is running. Additionally, UE 110 may stop the discontinuous coverage maximum time offset timer and initiate NAS signaling if UE 110 receives paging message, has pending emergency services, is establishing an emergency protocol data unit (PDU) session or is performing emergency services fallback procedure or UE 110 enters a tracking area identifier (TAI) outside the registration area. At expiry of the discontinuous coverage maximum time offset timer, UE 110 may perform a registration procedure for mobility registration update.

In an event that the end of unavailability period report indicates “UE does not need to report end of unavailability period” then, upon returning in coverage of a TAI in the current registration area, UE 110 may choose an appropriate substate of 5GMM-REGISTERED and does not need to perform a registration procedure for mobility registration update due to end of the unavailability period. For instance, in case that UE 110 is in a registered state, then UE 110 may enter a state of 5GMM-REGISTERED. NORMAL-SERVICE. Additionally, in case that UE 110 is in a de-registered state, then UE 110 may enter a state of 5GMM-DEREGISTERED. NORMAL-SERVICE. Moreover, in case that UE 110 is performing a search in the registered state, then UE 110 may a state of 5GMM-REGISTERED. PLMN-SEARCH. Furthermore, in case that UE 110 is performing a search in the de-registered state, then UE 110 may enter a state of 5GMM-DEREGISTERED. PLMN-SEARCH.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to unavailability period and coverage notification indication in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to unavailability period and coverage notification indication in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example process 300.

### Illustrative Processes

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to unavailability period and coverage notification indication in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210, as a UE, determining whether the UE needs to report an end of an unavailability period to a network upon returning in coverage after being in discontinuous coverage. Process 300 may proceed from 310 to 320.

At 320, process 300 may involve processor 212 performing, responsive to the determining, either or both of the following: (a) entering a 5GMM state depending on a state of the UE; and (b) controlling a wait timer according to the determining.

In some implementations, in entering the 5GMM state, process 300 may involve processor 212 entering a state of 5GMM-REGISTERED responsive to determining that the UE does not need to report the end of the unavailability period.

In some implementations, in entering the 5GMM state, process 300 may involve processor 212 entering a state of 5GMM-REGISTERED. NORMAL-SERVICE responsive to the UE being in a registered state.

In some implementations, in entering the 5GMM state, process 300 may involve processor 212 entering a state of 5GMM-DEREGISTERED. NORMAL-SERVICE responsive to the UE being in a de-registered state.

In some implementations, in entering the 5GMM state, process 300 may involve processor 212 entering a state of 5GMM-REGISTERED. PLMN-SEARCH responsive to the UE performing a search in a registered state.

In some implementations, in entering the 5GMM state, process 300 may involve processor 212 entering a state of 5GMM-DEREGISTERED. PLMN-SEARCH responsive to the UE performing a search in a de-registered state.

In some implementations, in controlling the wait timer, process 300 may involve processor 212 not starting the wait timer responsive to determining that the UE does not need to report the end of the unavailability period. In some implementations, the wait timer may include a discontinuous coverage maximum NAS signaling wait timer.

In some implementations, in controlling the wait timer, process 300 may involve processor 212, in an event that the wait timer is running, stopping the wait timer responsive to determining that the UE does not need to report the end of the unavailability period. In some implementations, the wait timer may include a discontinuous coverage maximum NAS signaling wait timer.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), whether the UE needs to report an end of an unavailability period to a network upon returning in coverage after being in discontinuous coverage; and
performing, by the processor responsive to the determining, either or both of:
entering a 5^{th} Generation Mobility Management (5GMM) state depending on a state of the UE; and
controlling a wait timer according to the determining.

2. The method of claim 1, wherein the entering of the 5GMM state comprises entering a state of 5GMM-REGISTERED responsive to determining that the UE does not need to report the end of the unavailability period.

3. The method of claim 1, wherein the entering of the 5GMM state comprises entering a state of 5GMM-REGISTERED. NORMAL-SERVICE responsive to the UE being in a registered state.

4. The method of claim 1, wherein the entering of the 5GMM state comprises entering a state of 5GMM-DEREGISTERED. NORMAL-SERVICE responsive to the UE being in a de-registered state.

5. The method of claim 1, wherein the entering of the 5GMM state comprises entering a state of 5GMM-REGISTERED. PLMN-SEARCH responsive to the UE performing a search in a registered state.

6. The method of claim 1, wherein the entering of the 5GMM state comprises entering a state of 5GMM-DEREGISTERED. PLMN-SEARCH responsive to the UE performing a search in a de-registered state.

7. The method of claim 1, wherein the controlling of the wait timer comprises not starting the wait timer responsive to determining that the UE does not need to report the end of the unavailability period.

8. The method of claim 7, wherein the wait timer comprises a discontinuous coverage maximum non-access stratum (NAS) signaling wait timer.

9. The method of claim 1, wherein the controlling of the wait timer comprises, in an event that the wait timer is running, stopping the wait timer responsive to determining that the UE does not need to report the end of the unavailability period.

10. The method of claim 9, wherein the wait timer comprises a discontinuous coverage maximum non-access stratum (NAS) signaling wait timer.

11. An apparatus implementable in a user equipment (UE), comprising:
a transceiver configured to communicate wirelessly; and
a processor coupled to the transceiver and configured to perform operations comprising:
determining whether the UE needs to report an end of an unavailability period to a network upon returning in coverage after being in discontinuous coverage; and
performing, responsive to the determining, either or both of:
entering a 5^{th} Generation Mobility Management (5GMM) state depending on a state of the UE; and
controlling a wait timer according to the determining.

12. The apparatus of claim 11, wherein the entering of the 5GMM state comprises entering a state of 5GMM-REGISTERED responsive to determining that the UE does not need to report the end of the unavailability period.

13. The apparatus of claim 11, wherein the entering of the 5GMM state comprises entering a state of 5GMM-REGISTERED. NORMAL-SERVICE responsive to the UE being in a registered state.

14. The apparatus of claim 11, wherein the entering of the 5GMM state comprises entering a state of 5GMM-DEREGISTERED. NORMAL-SERVICE responsive to the UE being in a de-registered state.

15. The apparatus of claim 11, wherein the entering of the 5GMM state comprises entering a state of 5GMM-REGISTERED. PLMN-SEARCH responsive to the UE performing a search in a registered state.

16. The apparatus of claim 11, wherein the entering of the 5GMM state comprises entering a state of 5GMM-DEREGISTERED. PLMN-SEARCH responsive to the UE performing a search in a de-registered state.

17. The apparatus of claim 11, wherein the controlling of the wait timer comprises not starting the wait timer responsive to determining that the UE does not need to report the end of the unavailability period.

18. The apparatus of claim 17, wherein the wait timer comprises a discontinuous coverage maximum non-access stratum (NAS) signaling wait timer.

19. The apparatus of claim 11, wherein the controlling of the wait timer comprises, in an event that the wait timer is running, stopping the wait timer responsive to determining that the UE does not need to report the end of the unavailability period.

20. The apparatus of claim 19, wherein the wait timer comprises a discontinuous coverage maximum non-access stratum (NAS) signaling wait timer.
